(19) United States
(12) Patent Application Publication
(10) Pub. No.: US 2007/0037470 A1
(43) Pub. Date: Feb. 15, 2007

(54) Water-powered lighted toys

(76) Inventor: Russell Rothan, Orlando, FL (US)

Correspondence Address: LINDA C. DOLAN, 255 S. ORANGE AVE., SUITE 1401, ORLANDO, FL, 32801, US

(21) Appl. No.: 11/450,183

(22) Filed: Jun. 9, 2006

Related U.S. Application Data
(60) Provisional application No. 60/690,849, filed on Aug. 9, 2005.

(51) Int. Cl. A63H 33/40; A63H 29/10

(52) U.S. Cl. 446/176

(57) ABSTRACT

A toy comprising a housing, a turbine-generator, and a light source. An inlet directs water into the housing and one or more outlets allow the water to exit as a stream or a spray or as a combination of the two. A turbine within the housing rotates in response to the force of the flowing water as it comes in contact with turbine vanes causing the turbine to rotate. The rotation of the turbine operates a generator to create electrical energy to light a light source. The light source will preferably be one or more light emitting diodes that respond to a control signal generated by a controller in an assembly carrying the light source. The control signal causes the lights to flash or to change color in accordance with the movement of the water or any other desired pattern.

### RELATED APPLICATION

This application claims priority from co-pending provisional application Ser. No. 60/690,849, which was filed on Jun. 15, 2005, and which is incorporated herein by reference in its entirety.

### FIELD OF THE INVENTION.

This invention relates to water activated toys and, more specifically, to a toy which includes a water-driven turbine serving to generate electrical power to energize a light source.

### BACKGROUND OF THE INVENTION

Water toys that encompass sprinklers and fountains are well known in the toy industry. For example, in U.S. Pat. No. 6,599,164 B1, Gerwitz describes a toy fountain that uses an ordinary garden hose to suspend a ball in the air on the exiting water stream. This patent was an improvement on U.S. Pat. No. 4,946,164, which used a fountain to suspend a ball in air as part of a baseball-like game. Other toy applications have used fountains as sprinklers for cooling off children on warm summer days.

However, the use of lights with fountain toys has not been prevalent since water used in combination with an electrical circuit of any type presents an electrical shock hazard. Still further to this problem, the supply of electricity to power such lights was traditionally by battery. Use of a battery meant that a special compartment had to be created in the toy to keep the battery and its associated circuitry dry. This presented a design problem, because the larger housing meant additional features would be needed to support the battery and safety features would be required to prevent access to the light circuit by children. This created the disadvantage of increased material costs for the manufacturer.

### SUMMARY OF THE INVENTION

The present invention advantageously overcomes these problems by comprising a toy that uses a water-driven turbine, rather than a battery, to power a light source. The result provides both light for entertainment and decorative purposes. The toy comprises three principal components: a housing, a turbine assembly, and a light assembly. An inlet allows water to enter the housing and at least one outlet is adapted for allowing water to exit the housing. A turbine assembly comprises a plurality of vanes about a turbine shaft so that the turbine is coupled in fluid communication with the water flowing between the inlet and an outlet. The flowing water presses on a vane positioned on the turbine shaft and moves the vane in the direction of the flowing water. Each subsequent vane on the turbine shaft is moved by the moving water causing the turbine to rotate about an axis along its shaft in response to the force applied by the water. As a result, the spinning turbine shaft creates mechanical energy, which may then be converted into electrical energy by means of an electromechanical generator. The electrical energy thus created can be used to power a light source. A light source is one component of a light assembly, which further comprises a controller for generating a control signal, and an integrated circuit for delivering the electrical energy to the various components of the light source assembly. The light source may be a lamp, an LED or a plurality of LEDs of different colors. The controller may be used to vary the color or the pattern of the light emitted.

### BRIEF DESCRIPTION OF THE DRAWINGS

Some of the features, advantages, and benefits of the present invention having been stated, others will become apparent as the description proceeds when taken in conjunction with the accompanying drawings, presented solely for exemplary purposes and not with intent to limit the invention thereto, and in which:

FIG. 1 is a side view of the present invention showing the turbine and generator as well as a light assembly operating on the principle of the water-driven turbine for producing a water fountain and electrical power for one or more LEDs;

FIG. 2 shows an embodiment of the toy as a fountain that can be used in the bathtub toy;

FIG. 3 depicts a hose for connecting to a faucet, shower or other source of water pressure, wherein the toy is connected to a faucet for operation;

FIG. 4 shows a view where multiple water-driven turbines may be connected in series to produce small fountains gushing water which the turbine uses to generate electrical power to light up each fountain with a predetermined color or combination of colors;

FIG. 5 shows another embodiment of the present invention, wherein a faucet provides the motivating water flow for the water-driven turbine to generate power and which then, in turn, lights up LED light sources; and

FIG. 6 is an exploded view showing the details of a turbine, a generator and a light source assembly in the embodiment illustrated in FIG. 5.

### DETAILED DESCRIPTION

The present invention will now be described more fully hereinafter, in which description preferred embodiments of the invention are discussed. Unless otherwise defined, technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. In addition, the materials, methods and examples given are illustrative in nature only and not intended to be limiting. Accordingly, this invention may be embodied in many different forms and should not be construed as limited to the illustrated embodiments set forth herein. Rather, these illustrated embodiments are provided solely for exemplary purposes so that this disclosure will be thorough and complete, and will fully convey the scope of the invention to those skilled in the art. Other features and advantages of the invention will be apparent from the following detailed description, and from the claims.

General Overview

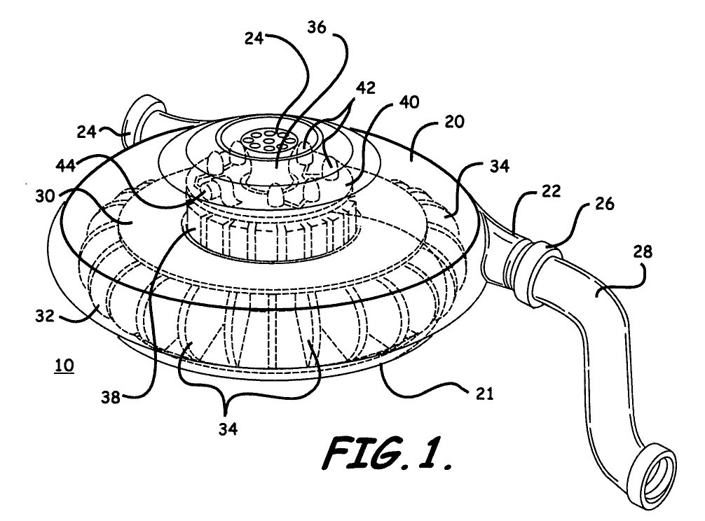

As noted above in the descriptions of FIGS. 1-6, the present invention may be variously embodied but relies on a water-driven turbine which rotates in response to water flow. The turbine powers a small generator that when coupled with appropriate electrical components as known in art, produces an electrical current sufficient to power one or more light sources, preferably light emitting diodes (LEDs). The combination of light and water effects produces amusement and may be adapted for use in a bathtub or shower, as well as an outdoor location such as a yard or garden.

Structural Detail

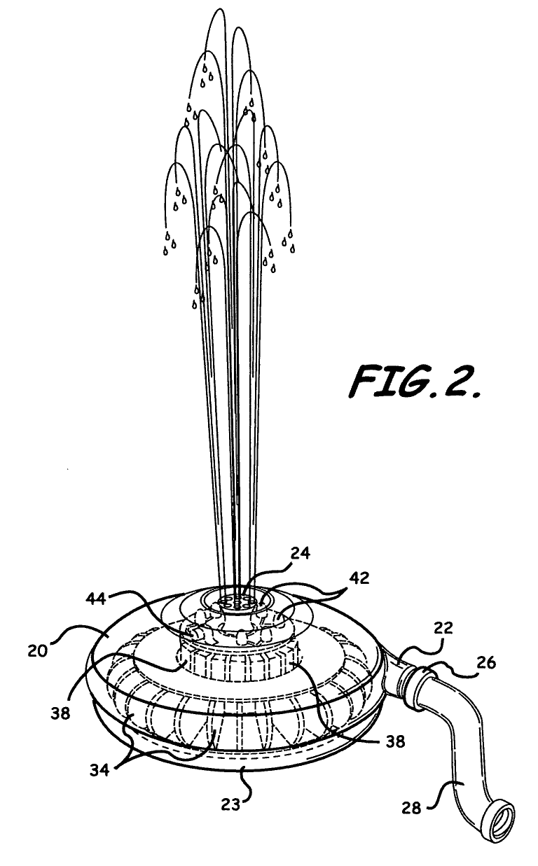

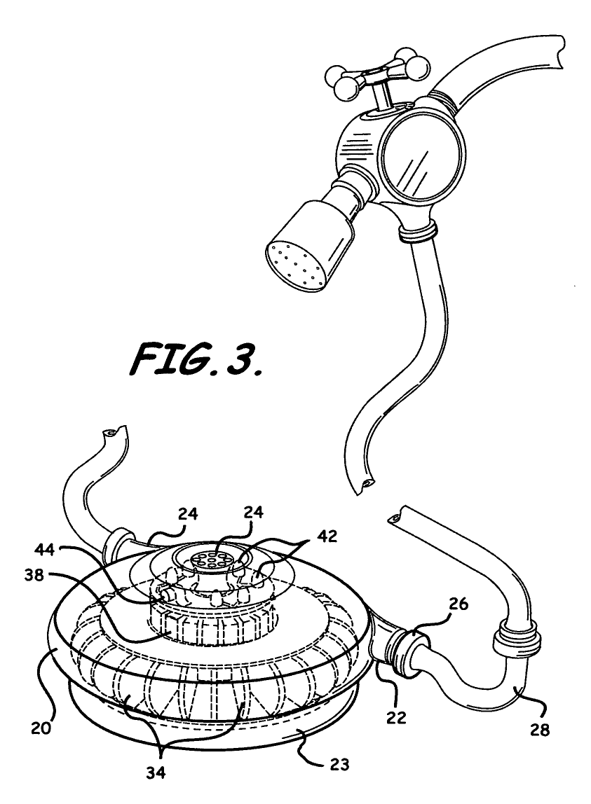

As illustrated in FIG. 1, a housing 20 is the first of the three major components of the lighted water toy. The housing 20 may be made of any opaque or transparent, waterproof material. In certain applications, a transparent material may be preferred so that the workings of the inner components of the toy are visible and, thus, contribute to the amusement provided by the toy. The housing 20 may have an essentially flat bottom 21 for sitting the lighted water toy on the ground. Alternatively, the toy may have a hull bottom 23, like that of a buoy or a boat, for use as a bathtub or swimming pool toy as depicted in FIG. 2. The housing 20 has an inlet 22 that allows water to enter and at least one outlet 24 adapted for allowing water to exit most preferably under a slight increase in pressure. The inlet 22 has a connector 26 which can be a threaded connector for attaching the toy to a hose or outside faucet, or which may have another design that would be suitable for attaching the toy to a bathtub faucet or a shower nozzle as shown in FIG. 3. The housing 20 will also have at least one outlet 24 to permit the water entering the housing to exit the housing as either a stream or a spray or as a combination of both.

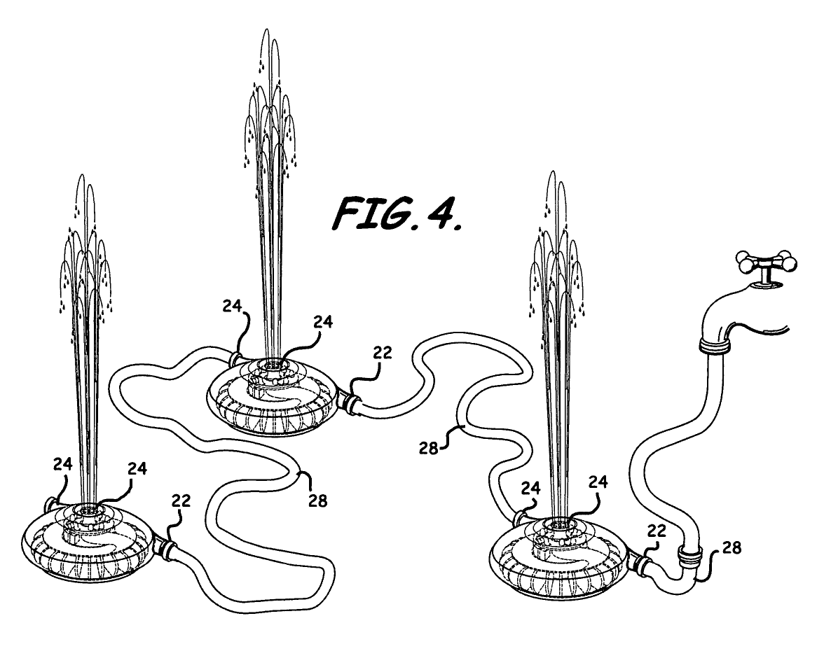

One embodiment of the present invention is a lighted water fountain 10, as shown in FIG. 1. The lighted water fountain 10 differs from related inventions, not only by its use of lights, but also by adding a controller for generating a control signal to vary the color, frequency or pattern of those lights. FIG. 4 illustrates how a group of these fountains might be joined in series. A conduit 28, such as a pipe or a garden hose, may be used to connect an outlet 24 of a first fountain to an inlet 22 of a second fountain, so that water entering one fountain passes to the next fountain, and then to a third fountain and so on. Those skilled in the art will recognize that the number of fountains that can be linked in this manner is limited only by the initial water pressure originating from a water source.

The second major component, shown in FIG. 1, is a turbine assembly 30. The turbine assembly 30 comprises an impulse type water-turbine 32, which operates as a stream of water entering the housing comes in contact with a vane or bucket 34, attached to a turbine shaft 36. The water-turbine 32 in fluid communication with the stream of water turns in the direction of a force exerted a by the water on each successive vane 34. The rotation of the water-turbine 32 creates mechanical energy that may be transferred to a generator 38. The generator 38 operates by converting the mechanical energy to electrical energy that can be used by a light source 42. The generator 38 can be of any type that is suitable for this purpose such as a simple magnetic coil, a magneto or an alternator. The skilled will recognize that the generator 38 preferably generates direct current.

The third component of the invention is a light source assembly 40. The light source assembly comprises a light source 42, such as a lamp or one or more LEDs; a controller 44 for generating a control signal 46; and an electric circuit 48 for carrying electrical energy to the various components of the light source. The light source 42 is generally one or more LEDs that may emit light as white light in the full range of the visible spectrum, as a single color, or as multiple colors. The controller 44 may be used to send a control signal to the light 42 to vary the color or the pattern of the light emitted. The controller 44 can be used to vary the colors and sequence as a function of water flow or of time with the result that different optical effects may be perceived. Examples of such optical effects include but are not limited to those known in the art as, “solid on”, “blinking”, “chasing” or “fading”.

Still further light effects may be obtained through the use of ultraviolet or near-ultraviolet LEDs, known in the vernacular as “black lights”. The skilled will recognize that the effect of the ultraviolet range may extend into some forms of blue light that are still considered to be within the visible spectrum. Those skilled in the art will also recognize that for particular applications, the use of such “black lights” may be enhanced by including fluorescent or phosphorescent materials or portions of such materials in the housing material to create enhanced lighting effects that would be responsive to ultraviolet light. By way of non-limiting examples, such materials may include calcofluor white, which produces a bright yellow color; rhodamine, which produces a red color, and fluorescein isothiocyanate, which produces a yellow-green color. As used herein, the term “fluorescent” will be used to encompass both fluorescent and phosphorescent materials, although technically the term “fluorescent” applies to materials that glow or fluoresce in the presence of ultraviolet light only, whereas the term “phosphorescent” applies to materials that continue to emit light for a time after the ultraviolet light source is removed.

An Alternate Configuration

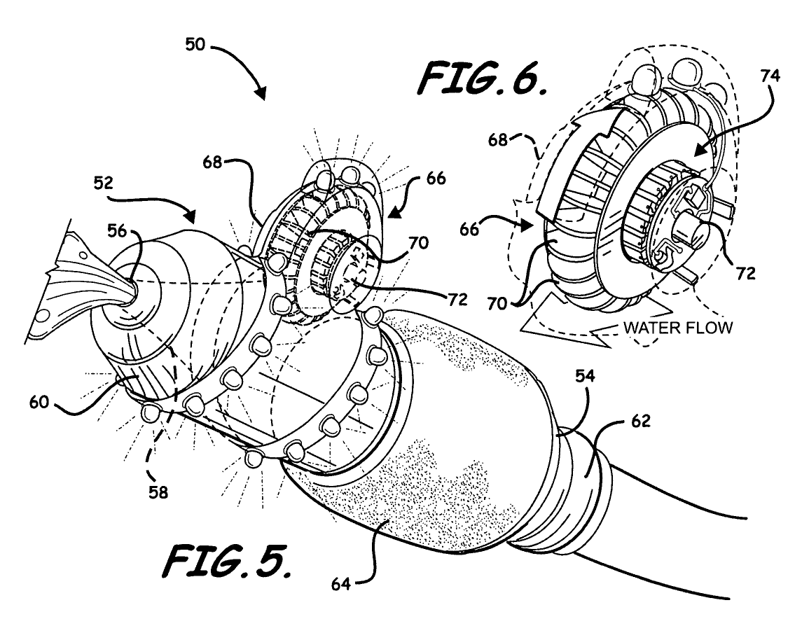

One specific embodiment of the invention that comprises the same elements arranged in a slightly different manner is a toy water nozzle 50 shown in FIG. 5. The toy water nozzle 50 comprises a nozzle housing 52 that ends in a taper 60 having the shape of a truncated cone having a water inlet 54 at the wider, base end and an outlet 56 at the opposite end to create a channel 58 for water flowing therebetween. The taper 60 of the housing causes a slight increase the pressure of the water stream exiting the nozzle. The inlet 54 has a connector 62 associated with the inlet 54 so that the nozzle 50 may be connected to a pressurized water source, such as a hose, a faucet, a pipe or any other water conduit. The nozzle housing 52 also incorporates a foam grip 64 on its exterior, which is used to hold the nozzle while it is in use.

In this embodiment, a water-turbine 66 is positioned within a chamber 68 attached to the exterior of the nozzle housing 52 so that it is at least partially in the channel 58 in order to contact the flow of water. The chamber may be made from a transparent material so that the working of the turbine may be seen. When the water entering the nozzle inlet 54 contacts a vane 70 on the water-turbine shaft 72, the vane 70 is moved in the direction of the flow, causing the water-turbine shaft 72 to rotate, thereby converting the kinetic energy of the flowing water stream to mechanical energy as shown in FIG. 6. To convert the mechanical energy to electrical energy, an electromechanical generator 74 is used. The resulting electric current from the electromechanical generator 74 is used to power a light source 76. The light source assembly 78 comprises one or more light sources 76, which are preferably LEDs; a controller 44 for generating a control signal 46, and an electric circuit 48 for carrying electrical energy to the various components of the light source assembly 78. As presently contemplated, the light source 76 may be configured as a band of lights encircling the nozzle 50, as LEDs located in the exterior chamber 68, as lights positioned elsewhere on the nozzle housing 52, or as any combination of these configurations.

Accordingly, in the specification there have been disclosed typical preferred embodiments of the invention, and although specific terms are employed, the terms are used in a descriptive sense only and not for purposes of limitation. The invention has been described in some detail, but it will be apparent that various modifications and changes can be made within the spirit and scope of the invention as described in the foregoing specification and as defined in the appended claims.

What is claimed is:

1. A toy comprising:
a housing having an inlet connectable to a source of water pressure for directing water into said housing and at least one outlet providing an exit from said housing for the water;
a turbine positioned in said housing in fluid communication with water flowing between the inlet and said at least one outlet of said housing;
a generator coupled to said turbine so that an electric current is produced when said turbine is activated by the flowing water; and
a light source associated with said housing and electrically connected to the generator for producing light when said turbine and said generator are activated.

2. The toy of claim 1 wherein said housing is substantially spherical with a flat bottom for sitting on the ground, said housing defining a chamber between said inlet and said at least one outlet for carrying said turbine therein.

3. The toy of claim 1 wherein said housing is substantially spherical and has a hull-shaped bottom effective for floating in water.

4. The toy of claim 1 further comprising:
an integrated circuit;
a controller connected in said integrated circuit for generating a control signal;
and wherein said light source includes
a plurality of light emitting diodes (LED) coupled to said controller and operating in response to the control signal.

5. The toy of claim 1, wherein said light source comprises multiple color LEDs.

6. The toy of claim 1, wherein said light source comprises an ultraviolet LED (UV-LED).

7. The toy of claim 1, further comprising a module for generating an audible sound.

8. A toy water nozzle comprising:
a tapered, cylindrically-shaped housing having a water inlet, an outlet and a conduit therebetween creating a channel for water flowing therethrough, the inlet being connectable to a source of water under pressure;
a grip disposed along an exterior portion of said housing for holding said nozzle;
a turbine carried by said housing in fluid communication with the water flowing through the channel, said turbine rotating in response to the flow of water creating mechanical energy thereby;
an electromechanical generator associated with said turbine for converting the mechanical energy to electrical energy; and
a light source operably connected to said generator so as to be energized by the electrical energy generated thereby.

9. The toy water nozzle of claim 8 further comprising:
an integrated circuit;
a controller connected in said integrated circuit for generating a control signal; and
a plurality of light emitting diodes (LEDs) coupled to said controller and operating in response to the control signal.

10. The toy water nozzle of claim 8, further comprising a module for generating sound.

11. The toy water nozzle of claim 8, wherein said plurality of light emitting diodes further comprises LEDs of different colors.

12. The toy water nozzle of claim 8, wherein said plurality of light emitting diodes includes one or more ultraviolet LEDs, and wherein said housing includes fluorescent material.

13. A lighted water fountain comprising:
a housing having an inlet, an outlet and a channel for water flowing therebetween;
a secondary outlet connected to and substantially smaller in size than said channel and extending upwardly from the channel;
a connector associated with said inlet for connecting to a water source;
a turbine carried by said housing in fluid communication with water flowing through said housing for creating mechanical energy by rotating in response to the flow of water;
a generator for converting the mechanical energy to electrical energy; and
a light source operably connected to said generator.

14. The water fountain of claim 13 wherein said housing is generally spherical and has a flat lower surface adapted for supporting said fountain on the ground, said housing defining a chamber therein, and wherein said turbine is positioned within the chamber.

15. The water fountain of claim 13, wherein said light source comprises at least one light emitting diode (LED) associated with said housing for generating the light.

16. The water fountain of claim 13, further comprising:
a controller associate with said light source for generating a control signal; and
at least one light emitting diode (LED) coupled to said controller and operating in response to the control signal.

17. The water fountain of claim 13, further comprises:
a module associated with said light source for generating sound.
